(19) United States
(12) Patent Application Publication
(10) Pub. No.: US 2022/0001222 A1
(43) Pub. Date: Jan. 6, 2022

(54) SYSTEM AND METHOD FOR USING A FIRE RESISTANT BLANKET FOR FIRE SUPPRESSION

(71) Applicant: Erez Dor, Rishon LeTsiyon (IL)

(72) Inventor: Erez Dor, Rishon LeTsiyon (IL)

(21) Appl. No.: 17/291,305

(22) PCT Filed: Nov. 12, 2019
(86) PCT No.: PCT/IL2019/051236

§ 371 Date: May 5, 2021

Related U.S. Application Data
(60) Provisional application No. 62/760,185, filed on Nov. 13, 2018.

(51) Int. Cl. A62C 3/02; B64D 1/18

(52) U.S. Cl. CPC A62C 3/0257; B64D 1/18; A62C 3/0242

(57) ABSTRACT

An airborne fire suppression system comprising a flying device, a deployment apparatus and folded fire suppressing blanket configured to allow quick and smooth deployment on or as a barrier to a forest fire or a building or other object on fire.

### RELATED APPLICATION/S

This application claims the benefit of priority under 35 USC §119(e) of U.S. Provisional Patent Application No. 62760185 filed Nov. 13, 2018, the contents of which are incorporated herein by reference in their entirety.

### FIELD AND BACKGROUND OF THE INVENTION

The present invention, in some embodiments thereof, relates to a fire suppression system and, more particularly, but not exclusively, to a Tire resistant blanket.

U.S. Pat. No. 6,125,941A appears to disclose, “A blanket for smothering fires or protecting items from fire, comprised of a wettable polymer capable of high volume water retention, a water reservoir and heat activatable valves or water source to permit water to flow from the reservoir to wet the polymer through gravity fed conduits. For fire extinguishing, such as well head fires, the blanket further comprises a heavy metal framework and an under-blanket support. The blanket is weighted and sized to cover the well-head fires with sufficient wetting to maintain it in place for sufficient time for smothering of the fire with an airtight closure. Uses of the reservoir-connected blanket include houses and mobile homes, protection suits and doorway mounts. In an embodiment used to protect valuable items, the polymer portion of the blanket is comprised of a tri-layer configuration of: a) a water tight liner to prevent water damage to the covered item, b) the wettable polymer, and c) a protective outer coat of a material such as glass fiber, kevlar and the like. If sufficiently stiffened, the polymer material can be utilized as a structural member in houses or boats with the water source being the river or other body of water the boat is set upon, or an existing sprinkler system in a house.”

U.S. Pat. No. 9,486,656B2 appears to disclose, “A blanket for fighting grass and scrub fires along a fire line includes a sheet of fire resistant material forming a lattice with multiple openings. The openings vary in size from larger openings along the sheet's from edge to smaller openings at the sheet's back edge. The lattice is preferably formed of woven Fire resistant fiberglass strips coated in vermiculite. The sheet is preferably rectangular, flexible for rolling, and multiple sheets may be lined up along the fire line. To preserve the shape of the sheet, connectors may secure the woven strips together at points where the woven strips overlap. The sheet can be placed atop or near grass or scrub at risk of burning, arranged with the front edge toward the fire and the back edge away from the fire. Once the burning risk passes, the sheet or sheets may be removed and rolled up for storage or transport.”

U.S. Pat. No. 5,608,992A appears to disclose, “a Fire isolation device for a free standing structure. This device includes a left tarp and right tarp fabricated from a fire resistant material. The left tarp and right tarp are of a size to completely enclose the free standing structure. Attached to the left tarp and right tarp is a support structure, which is capable of moving from an upward position where the left tarp and the right tarp completely enclose the free standing structure to a downward position where the left and right tarp expose the free standing structure. This device also includes a moving mechanism for moving the plurality of support members from the downward position to the upward position.”

China Patent No 102416231A appears to disclose, “a Fireproof isolating blanket for forest fire control, comprising a plurality of pieces of fireproof isolating cloths. Quick connecting pieces are arranged among all the fireproof isolating cloths. In the fireproof isolating blanket, the spreading of the forest fire can be effectively prevented by the quick connecting pieces of the fireproof isolating cloths, and the effect is good. The fireproof isolating blanket can be used as firefighting equipment which is necessary in a forest fire control unit.”

### SUMMARY OF THE INVENTION

According to an aspect of some embodiments of the invention, there is provided a fire suppressing system including: a fire resistant blanket, in a reduced surface area configuration, thickened portions the blanket; an extender configured to extend the blanket over a target zone; a guide configured to spread the blanket laterally as it is extended; the guide including a narrow passage through which passes a thin portion of the blanket while the thickened portion is retained on one side of the narrow passage.

According to some embodiments of the invention, the extender is configured to extend the blanket longitudinally or over the target zone.

According to some embodiments of the invention, the thickened portions are integrated into the blanket.

According to some embodiments of the invention, the thickened portions include a thickened longitudinal line.

According to some embodiments of the invention, the system further includes: a wind sheltering component configured to reduce an impact of wind on the blanket during deployment thereof.

According to some embodiments of the invention, the system further includes: a lifting component configured to change a distance of a part of the system to a ground without changing a distance of a transport to which the system is coupled to the ground.

According to some embodiments of the invention, the system further includes: a lifting component configured to change a distance of a part of the system to a transport apparatus to which the system is coupled.

According to some embodiments of the invention, the system further includes: a safety disconnecting device configured to disconnect at least one member selected from the set consisting of the extender, the guide and the blanket from a transport apparatus that is transporting the system.

According to some embodiments of the invention, the system further includes: an applicator configured for applying a fire suppressing material.

According to some embodiments of the invention, the system further includes: a retainer configured for holding the blanket in the reduced surface area configuration.

According to some embodiments of the invention, the retainer is configured to hold the blanket above a deployment zone and release the blanket from the reduced surface area configuration.

According to some embodiments of the invention, the system where the extender includes at least one member of the set consisting of an anchor, a weight, an attachment mechanism, a pulley, a drive wheel, and an airflow manipulation device.

According to some embodiments of the invention, the system further includes a transport apparatus configured for transporting the, blanket in the reduced surface area configuration over a target.

According to some embodiments of the invention, the transport apparatus is further configured for transporting the extender.

According to some embodiments of the invention, the transport apparatus is further configured to release the extender over a target region.

According to some embodiments of the invention, the extender includes at least one member of the set consisting of an anchor, a weight, an attachment mechanism, and an airflow manipulation device.

According to some embodiments of the invention, the system further includes a stationary deployment apparatus configured for suspending a portion of the blanket in the reduced surface configuration over a target while the blanket is extended.

According to some embodiments of the invention, the transport apparatus includes at least one member of the set consisting of a fixed wing aircraft, a rotating wing aircraft, a ground vehicle and a wafer vehicle.

According to some embodiments of the invention, the guide includes an airflow manipulation device configured to control a position of the blanket as it is deployed.

According to some embodiments of the invention, the system includes an airflow manipulation device configured to control a position of the blanket as it is deployed.

According to some embodiments of the invention, the guide includes a ring and wherein the narrow passage includes a gap in the ring.

According to some embodiments of the invention, the thickened portion includes at least one line running along an edge of the blanket.

According to some embodiments of the invention, the narrow passage includes a friction reducing mechanism.

According to some embodiments of the invention, the friction reducing mechanism includes a rolling element.

According to some embodiments of the invention, the system further includes a flattening apparatus.

According to some embodiments of the invention, the system further includes a refolding apparatus.

According to some embodiments of the invention, the system further includes a location indicator attached to the blanket.

According to some embodiments of the invention, the retainer includes a roller configured to roll up or unroll the blanket.

According to some embodiments of the invention, the system further includes a deployment speed configured to limit a rate of extending of the blanket.

According to an aspect of some embodiments of fire invention, there is provided a method of fire suppression including: transporting a fire resistant blanket in a reduced surface area configuration to a target, suspending the blanket over the target; spreading the blanket laterally [symbol] during the suspending.

According to some embodiments of the invention, the method further includes extending the blanket longitudinally during the spreading.

According to some embodiments of the invention, the method further includes unfolding the blanket during the spreading.

According to some embodiments of the invention, the method further includes: anchoring a trailing portion of the blanket onto a starting position and extending the blanket front the trailing portion over the target.

According to some embodiments of the invention, the method further includes anchoring a top portion of the blanket onto a starting position and spreading the blanket downward from the top portion over the target.

According to some embodiments of the invention, the method further includes: selecting a burning location as the target.

According to some embodiments of the invention, the method further includes: selecting a location in a path of a fire as the target.

According to some embodiments of the invention, the method further includes: selecting a location protecting an escape route from the fire as the target.

According to some embodiments of the invention, the method further includes: applying a fire suppressing chemical to at least one of the target or the blanket.

According to some embodiments of the invention, the suspending and the spreading are from a flying aircraft.

According to some embodiments of the invention, the extending includes attaching a top portion of the blanket to a building and draping a lower portion of the blanket over a wall of the building.

According to some embodiments of the invention, the spreading includes passing an edge of the blanket along a guide.

According to some embodiments of the invention, the spreading includes at least one of weighing down a lower portion of the blanket or spreading the blanket due to airflow resistance.

According to some embodiments of the invention, the method further includes: wrapping the blanket around a building.

According to some embodiments of the invention, the method further includes: retrieving the blanket after the spreading.

According to some embodiments of the invention, the method further includes: refolding the blanket.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In ease of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a perspective view of a fire suppression system in accordance with an embodiment of the current invention;

FIG. 2A is a schematic diagram of a guide of a spreading apparatus for a fire resistant blanket in accordance with an embodiment of the current invention;

FIG. 2B is a schematic diagram of a line and blanket passing through a guide of a spreading apparatus of a fire resistant blanket in accordance with an embodiment of the current invention;

FIG. 2C is a schematic diagram of an alternative guide of a spreading apparatus for a fire resistant blanket in accordance with an embodiment of the current invention;

FIG. 3A is a perspective view of a system for deploying a fire suppression system in accordance with an embodiment of the current invention;

FIG. 3B is a perspective view of a system for deploying a fire suppression system in accordance with an embodiment of the current invention;

FIG. 3C is a perspective view of a system for deploying a fire suppression System in accordance with an embodiment of the current invention;

FIG. 4 is a perspective view of a stationary system for deploying a fire suppression system in accordance with an embodiment of the current invention;

FIG. 5 is a perspective view of a system for deploying a fire suppression system to a building in accordance with an embodiment of the current invention;

FIG. 6 is a is u schematic diagram of a refolding apparatus for a fire resistant blanket in accordance with an embodiment of the current invention;

FIG. 7 is an exemplary block diagram illustrating the relationship between the components of a fire suppression system in accordance with an embodiment of the current invention;

FIG. 8 is a flow chart illustration of a method of suppressing fire in accordance with an embodiment of the current invention;

FIG. 9 is a flow chart illustration of a method of deploying a blanket in accordance with an embodiment of the current invention;

FIG. 10 is a flow chart illustration of deploying a blanket an accordance with an embodiment of the current invention; and

FIG. 11 is a schematic illustration of a fire suppression system in accordance with an embodiment of the current invention.

### DESCRIPTION OF SPECIFIC EMBODIMENTS OF THE INVENTION

The present invention, in sonic embodiments thereof, relates to a fire suppression system and, more particularly, but not exclusively, to a fire resistant blanket.

### Overview

An aspect of some embodiments of the current invention relates to a fire suppression system including a blanket that and/or a deployment apparatus. In some embodiments of the present invention the deployment from the air (e.g., using an airborne vehicle) and/or from an on the ground system, for example a motorized ground vehicle and/or from a stationary system. For example, the deployment vehicle may raise the fire suppressing blanket to a sufficient deployment height.

Optionally, the system is comprised of one or more subsystems that may function together and/or separately, in parallel and/or sequentially. Optionally, part or all of the system may be carried inside and/or outside of one or more flying devices. For example, a flying device may include, but is not limited, to: airplanes, drones, helicopters, balloons, rockets and projectiles of any son.

In some embodiments, an airborne fire suppression system includes a fire suppressing blanket subsystem that may have some or all of the following attributes:

In some embodiments, the “fire suppressing blanket” subsystem may include a material that is able to endure high temperatures without disintegrating, for example, but not limited to, aramid, carbon fiber, glass fiber, and/or aluminum foil.

In some embodiments, the “fire suppressing blanket” subsystem optionally has a reduced external surface configuration. The reduced external surface configuration may facilitate storage and/or transport of the blanket. For example, the external surf ace may be reduced by folding the blanket and/or collecting the blanket into a retainer and/or rolling the blanket into a roll and/or onto a roller. For example, the folding may be organized and/or random folding.

In some embodiments, the “fire suppressing blanket” subsystem is folded in a way that facilitates fast deployment For example, a fast deployment folding method may include, but is not limited to, the fast deployment folding methods as used in parachutes, greenhouse plastic film, small size fire blankets and/or seep prevention underground plastic sheets. Components facilitating fast deployment may include thick parts, cables, weights or other components that may be incorporated into the blanket and/or may be separate from the blanket.

In some embodiments the system includes an extender. Optionally, the extender may force the blanket to extend away from the deployment apparatus and/or away from its surface reduced configuration. For example, a blanket may be extended longitudinally outward from the deployment apparatus and/or longitudinally away from a retainer that holds the blanket in a surface area reduced state. For example, an extender may include an anchor that holds a trailing end of the blanket stationary while the leading end of the blanket is pulled away. For example, as the leading end of the blanket is pulled away, the blanket may be released from a surface area reduced stale and/or extend. For example, an anchor may include a weight and/or an attachment mechanism. For example, the attachment mechanism may attach part of the blanket to a stationary object. Alternatively or additionally, and extender may include a free weight. For example, a portion of a blanket may be suspended while the free weight extends an edge of the blanket downward away from the suspended portion. Alternatively or additionally, an extender may include an airflow manipulation device (for example a parachute and/or a fin). For example, a parachute may be attached to a trailing end of the blanket and/or pull the trailing edge of the blanket away from a moving leading portion of the blanket. Alternatively or additionally, an extender may include a mechanical system that extends and/or releases the blanket. For example, an extender may include a pulley that pulls an edge of a blanket along a stationary frame and/or a drive wheel that moves with an edge of the blanket (for example along a track) (e.g. while an opposing edge is held stationary thereby extending the blanket).

As used here, when the system has a defined direction of movement (e.g. the direction of movement of a transport vehicle transporting the blanket and/or deployment apparatus during deployment), longitudinal means parallel to the direction of movement, with respect to the target and/or lateral means perpendicular thereto. Where the direction of movement of the system is not clearly defined (for example a stationary deployment apparatus) the definition of the direction of movement may be defined as a direction of movement of the center of mass of the blanket with respect to the target. In eases where the center of mass of the blanket is not moving, lateral spreading is defined as spreading where two parts of a blanket spread in opposite directions with respect to the deployment apparatus and/or longitudinal spreading is defined as spreading where a first edge of the blanket is stationary with respect to the ground and/or the deployment apparatus and another edge of the blanket spreads way from the first edge.

In some embodiments, an airborne fire suppression system includes a deployment subsystem. Optionally the deployment subsystem is adapted to deploy the Fire suppressing blanket from its reduced surface configuration to its spread out configuration. For example, deployment may include, but is not limited to, the deployment methods used in curtains rails, parachutes, home size fire blankets, seep prevention underground plastic sheets, aircraft emergency slides, deployment of nets of all sorts and other methods.

In some embodiments of the present invention the fire suppressing blanket may include stabilizing components added to it or integrated into its structure. For example, the stabilizing components may facilitate spreading and maintaining its spread shape as the blanket descends to its designated covering area. Optionally, the stabilizing component includes, but is not limited to, weights, lead weights, metallic cables, holes or gaps in the blanket structure (for example, holes or gaps designed to reduce air resistance), parachutes and/or nets.

Some embodiments of the present invention may include a closing mechanism to close holes or gaps in the fire suppressing blanket. Optionally, the closing mechanism includes a mechanical and/or structural feature that closes holes or gaps after the deployment. For example, the closing mechanism may include, but is not limited to: an elastic band, a sliding mechanism, and/or a motorized device. Optionally, the closing mechanism may be remote controlled and/or automatic.

In some embodiments of the present invention (lie deployment subsystem guides and/or pushes an extremity of the blanket away from the center of the blanket and/or away from another extremity of the blanket. For example, the pushing mechanism may include, but is not limited to, explosives and/or combustible materials, compressed gas, mechanical pushing devices (like springs or rubber bands), motorized devices like moving arms or drones and/or a guide.

In some embodiments of the present invention the fire suppressing blanket may have an elongated shape (for example a strip).

Some embodiments of the present invention may include a blanket retrieval system. For example, the retrieval system may facilitate retrieval of the fire suppressing blanket from the air and/or from the ground. The blanket is optionally retrieved for reuse. The retrieving system may include features incorporated into the blanket including an attachment mechanism. For example, the attachment mechanism may include, but is not limited to, a cable and/or other device configured for attachment to an aircraft. Optionally, the aircraft attaches itself to the attachment device and/or uses the attachment device to pull the blanket upwards.

In some embodiments of the present invention a cable is incorporated into the fire suppressing blanket in a way that allows the blankets' edges to be raised up ahead of the center of the blanket or ahead of oilier parts of the blanket to avoid entanglements in the retrieving process.

In some embodiments, a retrieval system may include a locating device. For example, the locating device may be configured to facilitate locating and/or engaging the blanket and/or a connecting point of the retrieval system. Optionally the locating device includes, but is not limited to, GPS, RP or other wireless transmitters and/or receivers, lighter than air balloons that are pre-inflated and/or inflated on demand, gravity based devices that include a heavy base at the bottom to allow other parts to stick out of the blanket surface and/or a light emitting device.

In some embodiments of the present invention there is a device enabling the control of the distance between an aircraft carrying a deploying apparatus (e.g., with the deploying apparatus hanging from the aircraft) and the deploying apparatus. For example, controlling the distance between the deploying apparatus and the aircraft may facilitate safe deployment and/or to prevent the wind created by the aircraft from impacting the fire and/or deployment of the blanket.

Some embodiments of the present invention may include a treatment subsystem. For example, a treatment subsystem may apply a fire retardant to, cool, soak and/or impregnate a blanket. The treatment subsystem may be attached to another subsystem and/or be carried by another aircraft. Optionally, the treatment subsystem may moisturize a blanket (e.g., with water or other fire suppressing liquids). Alternatively or additionally, the treatment subsystem may treat the blanket with a gas and/or a solid (e.g., a powder). Optionally, the blanket is treated while it is deployed. Treatment may be from under the blanket or from above it and/or both. Optionally, the treatment subsystem includes a liquid and/or gas conveying and/or distributing device, for example a dripper, a mist creating system, an atomizer, and/or a powder spreader.

In some embodiments of the present invention the “fire suppressing blanket” deployment subsystem comprises a component of a wind breaker. For example, a wind breaker may be designed to protect the blanket as it is deployed.

In some embodiments of the present invention the fire suppressing system may have a control subsystem that controls at least one of the variables of the system, for example: the rale of deployment, the angle of the deployment in relation to the ground or in relation to flight direction of the aircraft and/or the distance between the subsystems. Optionally, the control subsystem is computer based. For example, the control subsystem may include a sensor.

In some embodiments of the present invention small devices could be incorporated into the blanket to facilitate rapid hanging of the blanket along its folding lines and/or to allow fast refolding of the blanket after recovery from the field for reuse. For example, small devices may be mounted along folding lines of the blanket. These small devices could include a coupler to attach objects to cables or ropes, for example, but not limited to key rings, Abseiling rings with or without springs, cord loops, and/or cables.

In some embodiments of the present invention a device could be incorporated into the system ensuring quick release of the blanket. For example, a quick release may facilitate the release of the blanket in ease of an emergency to prevent danger to an aircraft, for example, when the blanket or another part of the system get entangled and/or in case the aircraft needs to perform an emergency landing.

### Exemplary Applications for a Blanket Based Fire Suppression Apparatus

In some embodiments a blanket based fire suppression apparatus is used to suppress an existing fire. For example, a blanket may be deployed directly on a fire and/or an object in flames (for example: a ship or an aircraft).

In some embodiments a blanket based fire suppression apparatus is used to block the advance of a fire. For example, a blanket may lie deployed in the advancing fire's path.

In some embodiments a blanket based fire suppression apparatus is used to create an escape route from a fire. For example, a blanket may be deployed along a pathway between a dangerous location and a safe location. For example, the dangerous location may be a location where there are people, valuable property and/or objects that, if burnt, may produce danger (for example, poisonous chemicals, explosives, etc.). Optionally, a blanket may have a special deployment cross-section adapted to a deployment at the edge of a forest to facilitate escape from a forest fire.

In some embodiments a blanket based fire suppression apparatus is used to cover an on ground structure. For example, the structure may be covered front the air by using an aircraft as a “transport apparatus” and/or dropping the blanket on the structure.

In some embodiments a blanket based fire suppression apparatus is used to cover an on ground structure from the ground by using an on land vehicle.

In some embodiments a blanket based line suppression apparatus is used to cover an on ground structure from the ground by using a stationery deployment apparatus. Optionally, the deployment apparatus may transport the blanket within a zone of the apparatus. Optionally, the stationary deployment apparatus includes moving parts.

In some embodiments a blanket based fire suppression apparatus is wrapped around a section of a multi-story building.

In some embodiments a fire suppression blanket is dropped onto a fire and/or in the path of fire and/or above a structure. Optionally, a fire suppressing material is applied on the deployment area along with the blanket. Optionally, the fire suppressing material is applied under and/or above the spread blanket.

In some embodiments a blanket based fire suppression apparatus is used to control a fire before setting the fire. For example, a blanket may be deployed around an area (at least from one side of said area, for example downwind of the fire setting zone). For example, a fire may be ignited in an area to prevent the spread of an uncontrolled fire (for example in the path of the uncontrolled fire).

In some embodiments, tactics may be developed ahead of time and/or a computerized decision assisting system may be used to collect data and prepare for future fires, for example in a high fire risk area. For example, the system may be used to determine, ahead of time, preferred deployment routes tor a fire blanket in a hypothetical fire event.

In some embodiments, the fire suppression system includes a spreading apparatus. For example, the spreading apparatus may include one or more guides. For example, there may be two guides that guide opposite lateral edges of the blanket away from each other. For example, the blanket may be spread laterally as the blanket is extended longitudinally. In some embodiments, the blanket may include a feature that connects to the guide. For example, there may be a thickened region (e.g. a line; along the edge of the blanket that passes through a hollow channel in the guide. Alternatively or additionally, a thickened portion may be integrated and/or coupled to the blanket in various geometries and/or ways. For example, the thickened portion may be a line running longitudinally and/or laterally along an edge and/or in a central portion of the blanket. Alternatively or additionally, a thickened portion may include a line and/or a coupler extending from the blanket for example, extending from the edge of the blanket and/or attached to the blanket. Optionally, a narrow opening in the channel allow a portion of the blanket to pass out of the hollow of the guide and/or between the two guides. As the blanket is deployed the edges of the blanket pass along the guides and spread out. Alternatively or additionally, the guide may include a track which attaches to extensions attached to an edge of the blanket (for example rings to slide along a pole and/or a carriage that moves along the track (e.g. a roller and/or a slider etc.)).

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

### DETAILED EMBODIMENTS

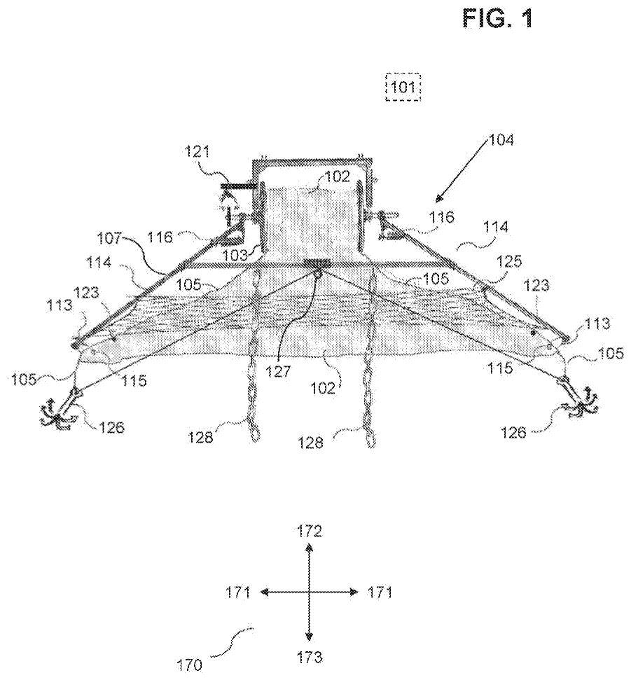

Referring now to the drawings, FIG. 1 is a perspective view of a fire suppression system in accordance with an embodiment of the current invention. In some embodiments, a blanket based fire suppression apparatus 101 is deployed to extinguish huge scale fires. Optionally, the blanket based fire suppression apparatus 101 comprises a folded fire blanket 102 and a deployment apparatus 104.

### Fire Blanket

In some embodiments, a fire blanket 102 includes a large sheet of flexible material and/or netting that is referred to herein as a blanket. A fire resistant blanket 102 is a blanket that partially or entirely, made of materials resistant high temperature and/or resistant to combustion. For example, for example heal and/or combustion resistant materials include fiberglass, carbon fiber, rock wool, Kevlar, Nomex, aluminum foil. Optionally, the fire blanket 102 is comprised of at least one material that was treated with at least one fire retardant. Optionally, the fire blanket 102 is treated with at least one fire retardant after its manufacture.

In some embodiments, the fire blanket 102 is manufactured through a process of weaving, sewing, netting, nonwoven fabric manufacturing methods, coupling thin metal sheets to other material or materials and/or a different process of a manufacturing. Optionally, the fire blanket 102 comprises at least one multilayered section. Optionally, the multilayered section of the fire blanket 102 has an increased fire resistance. Optionally, the multilayered section of the fire blanket 102 with increased fire resistance is located in the part of the fire blanket 102 that is expected to have direct contact with fire.

In some embodiments, the blanket has a reduced surface configuration (e.g., a gathered configuration where the blanket, is gathered together). Optionally, in the gathered configuration, the blanket may be folded and/or rolled up. For example, the gathered configuration may be configured to facilitate transportation and/or storage. For example, in the gathered configuration, the blanket may be gathered to reduce Us total surface area. For example, before being deployed, the surface of the folded fire blanket 102 may be smaller than the surface of the fire blanket when it is spread out.

In some embodiments, prior to deployment, the surface area of the fire blanket 102 is reduced by folding the fire blanket, rolling the fire blanket, gathering the fire blanket from the edges toward a specific spot or a line, in an organized or a random arrangement, restraining it inside a sleeve or other object and/or by employing another method of reducing the surface area of an object. For example, the fire blanket, may be restrained inside a sleeve comprised of Fabrice and/or a not inside a net and/or inside another object. Optionally, the fire blanket 102 is folded in a way that is similar to the way parachutes, greenhouse cover film and home fire blankets are folded prior to deployment. In some embodiments the blanket 102 is long and thin. For example, the longitudinal length of the blanket may be between 2 to 5 times and/or 5 to 20 times and/or 20 to 100 times and/or 100 to 1000 times its lateral width in an unfolded/extended state. Optionally in a surface reduced configuration, the blanket is longitudinally rolled up around a retainer and/or folded laterally. Alternatively or additionally, in a surface reduced configuration, the blanket is longitudinally folded, (for example, folded in alternating folds like an accordion). Alternatively or additionally, the blanket may be square and/or have equal longitudinal length and lateral width. Alternatively or additionally, a lateral dimension of the blanket may be greater than its longitudinal dimension.

In some embodiments the blanket based fire suppression apparatus 101 comprises a folded blanket retainer 103. The word retainer is used here in a broad sense for any storage device which retains the blanket in a gathered form. For example, the retainer may include a cavity into which the blanket is inserted and/or a form around which the blanket is folded and/or rolled (for example, the folded blanket retainer 103 may include a rotating drum. Optionally, the fire blanket 102, in a folded configuration, is rolled around the folded blanket retainer 103. Optionally, the folded blanket retainer 103 holds the fire blanket 102 in a gathered configuration until it is unfolded and/or deployed.

In some embodiments the blanket retainer 103 delivers the folded fire blanket 102 to the deployment apparatus 104. Optionally, the folded blanket retainer may be active. For example, parts of the retainer 103 may move with respect to each other to deploy and/or gather the blanket 102. Alternatively or additionally, parts of the folded blanket retainer 103 may move with respect to parts of the deployment apparatus 104. Optionally, the moving parts of the folded blanket retainer 103 and deployment apparatus 104 move in order to deploy the folded fire blanket 102. For example, deployment apparatus 104 may include a rotating drum that rotates around an axle to deploy and/or regather the fire blanket 102. Alternatively or additionally, the retainer may be passive.

In some embodiments the deployment apparatus 104 comprises a guide. For example, the guide may include two rings 113 and/or a spreading apparatus 114. For example, spreading apparatus 144 may unfold the blanket 102 as it is deployed. Optionally, the deployment apparatus 104 is configured to receive the fire blanket 102 in a folded configuration. Optionally, the delivery of the folded fire blanket 102 to the deployment apparatus 104 by the retainer 103 facilitates the deployment process. Optionally, the deployment apparatus 104 is configured to unfold the folded fire blanket 102. Optionally, the deployment apparatus 104 unfolds the folded fire blanket 102 until it reaches a desired spread configuration and/or shape. Alternatively or additionally, rings 113 could be replaced by other sorts of guides that spread the blanket laterally and/or allow the blanket to extend longitudinally (distally) out of the apparatus, a set of axes 170 indicate the lateral direction 171 and (longitudinal) proximal direction 172 and distal direction 173.

In some embodiments, a ring and/or the hollow of the ring may have a circular cross section. Alternatively or additionally, a ring and/or the hollow thereof may have an arbitrary cross section, for example rectangular, triangular, irregular.

In some embodiments the blanket retainer 103 contains the fire blanket 102 in a reduced surface area configuration, for example, as described above. For example, the blanket retainer 103 may restrain the fire blanket 102 by rolling the fire blanket 102 on a rolling dram and/or rolling it on another rolling device. In some embodiments, the fire blanket 102 is folded and/or the folded fire blanket 102 is gathered from an edge of the blanket 102 towards a designated or random point or line. For example, the blanket may be placed loosely, und/or folded, in and/or onto a retainer capable of retaining it in the gathered configuration. For example, the folded fire blanket 102 may be rolled on a rolling drum in a way that is similar to the way that a garden hose is wrapped around a rolling drum. For example, the fire blanket retainer 103 may include a box or other retainer, net, bag, platform and/or other structure capable of holding the fire blanket 102. Additionally, or alternatively, the blanket retainer 103 comprises a hanging device from which the fire blanket 102 hangs. Optionally, the fire blanket 102 hangs loosely from the hanging device. Additionally, or alternatively, the blanket retainer 103 comprises a sleeve made of Fabrice, a net or another object capable of restraining the fire blanket 102.

In some embodiments the blanket retainer 103 partially or fully comprises fire resistant materials. Additionally, or alternatively, the blanket retainer 103 does not comprise fire resistant materials.

In some embodiments, blanket based fire suppression apparatus 101 comprises a deployment flattening apparatus 128, for example, chains. The flattening apparatus is optionally configured to apply pressure on the surface of the blanket 102 after it has been unfolded and/or deployed. For example, pressure and/or flattening may reduce the amount of air trapped under the blanket. Less air under the blanket optionally increases the efficiency of the fire suppression. Non-limiting examples for types of components of the post deployment flattening apparatus include a heavy cable and/or a chain 128.

### Exemplary Deployment of a Fire Suppression System

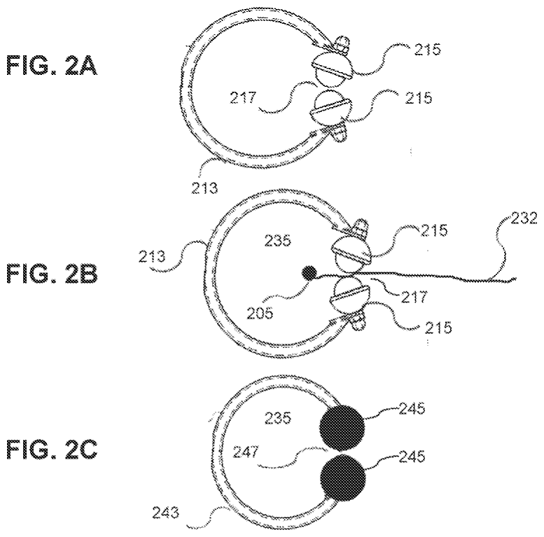

In some embodiments, the deployment apparatus 104 deploys the folded fire blanket 102 by spreading it out above and/or to the side of a fire and/or as an obstacle in the path of a fire. Optionally, the thickened lines 105 running along the opposite edges of the folded fire blanket 102 are each threaded through a channel in a guide. For example, a channel may include a hollow 235 of a ring 113 behind narrow passages 217 (depicted in FIG. 2A as a gap) in the rings 113 of the deployment apparatus.

In some embodiments the deployment apparatus KM comprises a spreading apparatus 114. Optionally, the spreading apparatus 114 receives the fire blanket 102 from retainer 103. Optionally, the spreading apparatus 114 receives the folded fire blanket 102 in its folded configuration. Optionally, the spreading apparatus 114 transforms the configuration of the folded fire blanket 102 to a desired deployed configuration. For example, in the deployed configuration the fire blanket 102 is spread out. Optionally, the spreading apparatus 114 spreads out the folded fire blanket 102 until it reaches a desired shape for deployment.

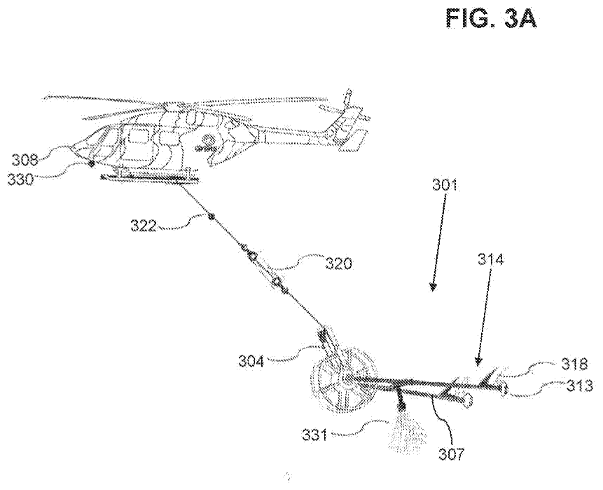

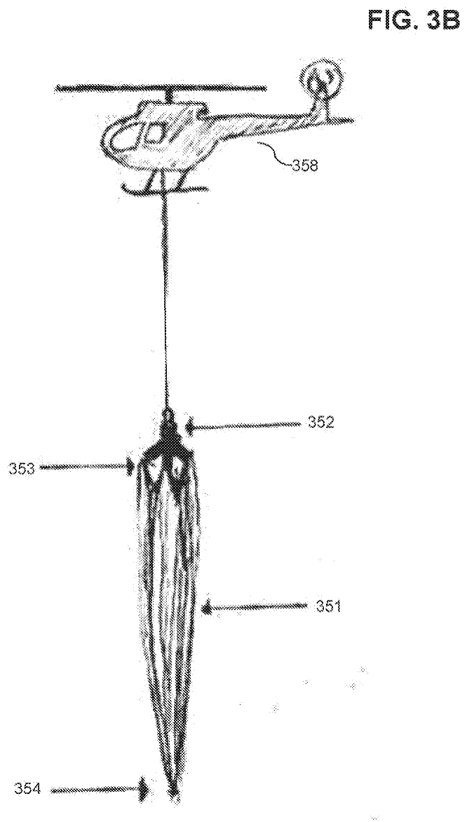

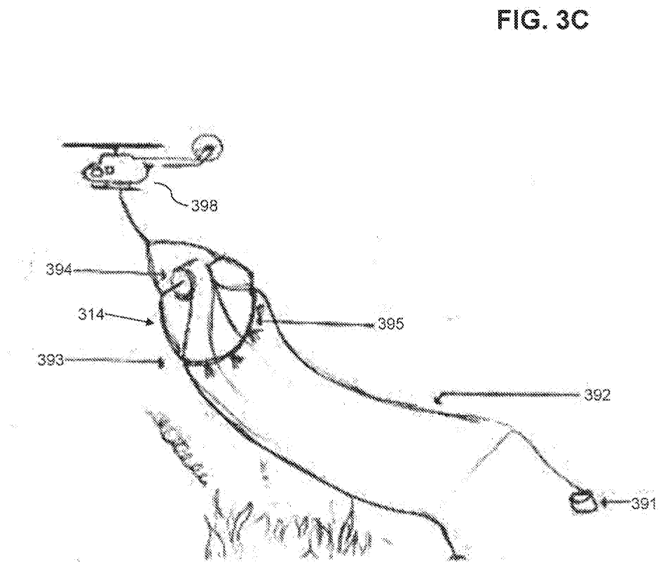

In some embodiments the spreading apparatus 114 comprises a rigid structure and/or semi rigid structure which spreads the blanket 102 as it is deployed. For example, two poles 107 may hold two rings 113 distanced from each other at the width of the deployed configuration of blanket 102. Alternatively or additionally, the structure is flexible. For example, guides such as rings 113 may be held by cables that are held apart by an airflow mechanism (e.g., as illustrated in FIG. 3A). Optionally, thickened lines 105 running along opposite longitudinal edges of blanket 102 are threaded through rings 113 (e.g., ring 213 of FIG. 2A), each having a narrow passage, (e.g., passage 217 of FIG. 2A). Optionally, the rings 113 are distanced from one another by the structure of the spreading apparatus 114. Optionally, as the thickened lines 105 are distanced from one another by the spreading apparatus 114, the thinner material of the folded fire blanket 102 runs through the passage (e.g., narrow passage 213 as illustrated in FIG. 2B) while the thickened lines 105 can slide inside the ring 113 behind the passage 217 but do not escape the ring 113. Alternatively or additionally, the blanket may have loops on the longitudinal edges that loop around poles 107. For example, as the blanket is deployed, the rings slide along a guide such as the poles 107, spreading the blanket until the loops slide off the end of the poles 107 releasing the spread out portion of the blanket.

In some embodiments the spreading apparatus 114 comprises flexible materials such as cables, wires and/or ropes. Optionally, the spreading apparatus 114 comprises metallic and/or non-metallic ropes. Optionally, the spreading apparatus 114 comprises one or more ropes operated by pulleys. Additionally, or alternatively, the spreading apparatus 114 comprises one or more ropes operated without pulleys.

In some embodiments one ring 113 incorporated into the deployment apparatus 104 is sufficient to deploy the fire blanket 102. Optionally, the rings 113 incorporated into the deployment apparatus 104 manipulate the fire blanket 102 into a desired shape. In some embodiments the spreading apparatus 114 utilizes the force of gravity to spread the folded fire blanket 102.

In some embodiments, at a deployment site, the fire blanket 102 is fed through the deployment apparatus 104. Optionally, as the fire blanket 102 is fed through the deployment apparatus 104, the thickened lines 105 are kept at a distance from one another by the rings 113. Optionally, as the fire blanket 102 is fed through the deployment apparatus 104, the fire blanket 102 is forced to spread between the thickened lines 105 that are kept at a distance from one another.

In some embodiments the blanket based fire suppression apparatus 101 comprises a deployment speed control device 121. Optionally, the deployment speed control device 121 controls the speed of the deployment of the fire blanket 102. Optionally, the deployment speed control device 121 detects and/or factors into consideration external factors. For example, the deployment speed control device 121 may detect und/or factor into consideration the force of the wind, the force of gravity and/or other forces applied to the fire blanket 102. Optionally, the deployment speed control device 121 overcomes external forces in order to control the speed of the deployment of the fire blanket 102.

In some embodiments the deployment speed control device 121 acts as a braking system and/or other type of stopping mechanism. In some embodiments the deployment speed control device 121 is controlled electronically and/or remotely and/or automatically. Additionally, or alternatively, the deployment speed control device 121 is controlled manually.

In some embodiments, the anchors 126 are coupled to the fire blanket 102. Optionally, an anchor 126 is dropped at a point designated as the initial deployment point within a designated deployment area. Optionally, one or more additional anchors 126 are dropped at one more additional points designated as the subsequent deployment points within the designated deployment area.

In some embodiments, the anchors 126 comprise a cushioning layer around the hard part of the anchor. Optionally, the cushioning layer reduces the severity of the impact of the anchors 126 with the surface on which they land and/or with objects or people inadvertently struck by the anchors 126.

In some embodiments, the anchors 126 comprise an alert or alarm system. Optionally, the alert or alarm system emits a loud sound when approaching a designated deployment area. Optionally, the loud sound alerts ground staff and/or other people near and/or in the designated deployment area of the approaching anchors 126.

In some embodiments the blanket based fire suppression apparatus 101 comprises an anchor release mechanism 127). Optionally, the anchor release mechanism 127 releases at least one anchor 126. Optionally, the anchor release mechanism 127 releases at least one anchor 126 at a location designated for the deployment of the fire blanket 102. Optionally, the anchor release mechanism 127 is operated manually and/or mechanically. Additionally, or alternatively, the anchor release mechanism 127 is operated electronically and/or remotely and/or automatically.

In some embodiments the blanket based fire suppression apparatus 101 comprises a wind sheltering component 125. For example, the wind sheltering component 125 reduces the impact of wind on the fire blanket 102 during the deployment process. For example, the wind sheltering component 125 may reduce the impact of wind on the fire blanket 102 as the fire blanket 102 traverses the distance from the blanket retainer 103 to the rings 113. Optionally, the wind sheltering component 125 reduces the impact of wind on the fire blanket 102 as the fire blanket 102 is deployed from an aircraft and/or from a high altitude.

### An Alternative Fire Suppression System

In some embodiments of the fire blanket 102 at least one of the thickened lines 105 is incorporated into the fire blanket 102 structure and/or is coupled to the fire blanket 102 at a point or points that are not along an edge of the fire blanket 102. For example, at least one of the thickened lines 105 may be incorporated into the fire blanket 102 and/or coupled to the fire blanket 102 along an interior part of the fire blanket 102.

### Firefighting Computerized Decision Assisting System

In some embodiments the blanket based fire suppression apparatus 101 comprises a firefighting computerized decision assisting system. Optionally, the firefighting computerized decision assisting system comprises at least one computing device and software capable of receiving, processing and/or analyzing data. Optionally, the software receives, processes and/or analyzes data stored in one or more databases. Optionally, the software receives, processes and/or analyzes data available on Google Earth. Optionally, the software receives, processes and/or analyzes data on one or more of the following items: available configurations of the blanket based fire suppression apparatus 101, active fires (including intensity, direction and speed of advancement and/or other factors), past fires, geographic information, density of trees and other vegetation, observations front ground sensors and/or above ground sensors (such as satellite and aircraft sensors), sensitive facilities, and/or ground staff activity. In some embodiments the firefighting computerized decision assisting system makes recommendations. Optionally, the recommendations are based on the processing and/or analyzing of received data. Optionally, the recommendations are applied to control the deployment mechanism and/or a navigation system and/or to send notifications to an operator. Optionally, the firefighting computerized decision assisting system makes recommendations concerning at least one of the following subjects: the best route of deployment of the blanket based fire suppression apparatus 101 in case of an active fire and/or a potential (future) fire; the optimal configuration of the blanket based fire suppression apparatus 101 in different hypothetical and/or active fire scenarios; whether to ignite a preemptive fire in different hypothetical and/or active fire scenarios. For example, the firefighting computerized decision assisting system may recommend whether or not the local fire department should ignite a controlled fire in a treed area near an active and/or potential future fire, after which the blanket basal fire suppression apparatus 101 would be used to help extinguish the ignited fire, thereby reducing the amount of fuel available to the original and/or potential future fire.

### Spreading the Fire Blanket

In some embodiments, before deployment, the fire blanket 102 comprises and/or is coupled to a plurality of thickened lines 105 that run along the length of the fire blanket 102. Optionally, the thickened lines 105 are elongated lines running along parts of the fire blanket 102. Optionally, the thickened lines 105 are situated on opposite sides of the fire blanket 102. Optionally, the thickened lines 105 are parallel, mostly parallel or partly parallel to one another.

In some embodiments, the thickened lines 105 are incorporated into the structure of the fire blanket 102 and/or are coupled to the fire blanket 102. Optionally, the thickened lines 105 are coupled to the fire blanket 102 by sewing or gluing the thickened lines 105 to the fire blanket 102 and/or by connecting the thickened lines 105 to the fire blanket 102 with at least one coupling element (such as a clip, a coupling ring, a string, a wire and/or another coupling element) and/or a detachable coupling element (such as scotch tape or other tape, a zipper, a detachable clip, a button and/or another detachable coupling element).

In some embodiments, the thickened lines 105 are thicker than the rest of the fire blanket 102 into which they are incorporated. Additionally, or alternatively, the thickened lines 105 are thicker than the majority of the fire blanket 102 into which they are incorporated. Additionally, or alternatively, the thickened lines 105 are thicker than the portion of the fire blanket 102 to which they are coupled.

In some embodiments, the thickened lines 105 are comprised of at least one fire resistant material. Additionally, or alternatively, the thickened lines 105 are comprised of at least one material that strengthens the thickened lines 105. For example, the thickened lines 105 may be comprised of steel wire, other metallic wires, non-metallic wire, Kevlar, fiberglass, a chain, a cable, carbon fiber, Nomex, and/or rope.

In some embodiments, the material comprising the fire blanket 102 is folded and sewn along the edges of the fire blanket 102 to create thickened lines 105.

In some embodiments, the thickened lines 105 are configured to manipulate the fire blanket 102. Optionally, the thickened lines 105 are configured to spread out the fire blanket 102. For example, the thickened lines 105 may be used to spread out the fire blanket 102 until the fire blanket 102 is completely spread out or is changed to another desired shape or form. For example, thickened lines 105 may be configured to pass through guides (for example rings 113) as the blanket is deployed. Optionally guides may include various forms that hold the lateral edges of the blanket apart while allowing the blanket to deploy longitudinally. For example, the guides may include a wall and/or a pipe with a narrow slit. The thickened portion of the blanket may be retained on the outside of the slits while the thin blanket passes through the slit between the guides. As the blanket is deployed, the thickened part of the edge of the blanket passes longitudinally behind and/or outside of the slits while the thin center of the blanket passes between the slits and the entire blanket slides longitudinally out of the deployment apparatus.

In some embodiments the deployment apparatus 104 comprises at least two rings 113. Optionally, the rings 113 are devices with at least one passage (e.g., passage 217 depicted in FIG. 2A) in its structure. Optionally, the width of passage 217 (depicted in FIG. 2A) determines the maximum dimensions of the objects that can pass through it. Optionally, passage 217 (depicted in FIG. 2A) is narrower than the thickness of the thickened lines 105 but is wider than the fire blanket 102. For example, passage 217 (depicted in FIG. 2A) may be wide enough to allow the fire blanket 102 to pass through when it is unfolded, but may not be wide enough to allow the thickened lines 105 to pass through.

In some embodiments the rings 113 are distanced front one another by the spreading apparatus 114. For example, the rings 113 may be coupled to the ends of the spreading apparatus 114.

In some embodiments the blanket based fire suppression apparatus 101 may be configured to spread the fire blanket 102 (for example unfolding it) as it moves along the spreading apparatus 114 toward the rings 113. Optionally, the distance the spreading apparatus 114 creates between the rings 113 is the desired final width of the fire blanket 102. For example, the blanket based fire suppression apparatus 101 may spread the fire blanket 102 as it moves along the spreading apparatus 114 toward the rings 113 until spreading apparatus the fire blanket 102 reaches its desired final width, spreading apparatus

In some embodiments the distances between at least two of the guides, for example, rings 113 is dynamic. Optionally, the distances between at least two of the guides may be changed to a desired distance. In some embodiments the spreading apparatus 114 comprises or is coupled to a configuration changing device 116. Optionally, the configuration changing device 116 reconfigures the spreading apparatus 114.

In some embodiments the configuration changing device 116 is controlled electronically and/or remotely and/or automatically. Additionally, or alternatively, the configuration changing device 116 is controlled manually. In some embodiments the configuration changing device 116 reconfigures the spreading apparatus 114 into different shapes. Optionally, as the shape of the spreading apparatus 114 changes, the distance between at least two of the rings 113 that are incorporated into the structure of the spreading apparatus 114 changes.

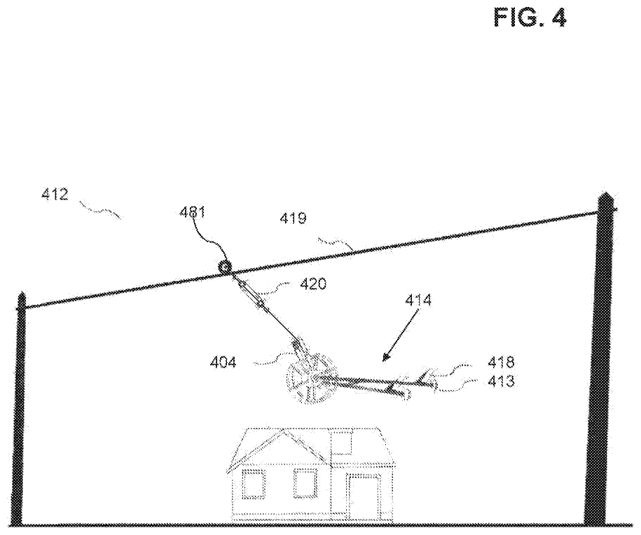

In some embodiments the configuration changing device 116 reconfigures the spreading apparatus 114 by moving it. For example, the configuration changing device 116 may move the spreading apparatus 114 with a servo motor, a hydraulic device, an electric motorized mechanism, another type of motor, an airflow manipulation device 318 (depicted in FIG. 3A), 418 (depicted in FIG. 4) and/or another mechanism for moving an object.

FIG. 2A is a schematic diagram of a guide of a spreading apparatus of a fire resistant blanket in accordance with an embodiment of the current invention. In some embodiments, rings 213 comprise at least one passage 217. Optionally, the width of passage 217 determines the maximum dimensions of the objects that can pass through it. Optionally, passage 217 is narrower than the thickness of the thickened lines 105 but is wider than the thickness of fire blanket 102 (depicted in FIG. 1). For example, passage 217 may be wide enough to allow the fire blanket 102 to pass through when it is unfolded (e.g., as depicted in FIG. 2B), but may not be wide enough to allow the thickened lines 105 to pass through.

In some embodiments the rings 213 comprise at least one friction reducing component 115 (depicted in FIG. 1). For example, the friction reducing element may include a rolling component, for example element 215 (depicted in FIG 2A and 2B). For example, the friction reducing clement 215 may be positioned on opposite sides of the narrow passage 217, facilitating passage of the blanket longitudinally through the narrow passage 217.

FIG. 2B is a schematic diagram of a line and blanket passing through a guide of a spreading apparatus for a fire resistant blanket 232 in accordance with an embodiment of the current invention. A thickened line 205 on the longitudinal edge of the blanket 232 is (rapped in the hollow 235 of the ring 213. Optionally, the thickened line 205 passes longitudinally through the ring as the blanket 232 spreads laterally and extends longitudinally out of the spreading apparatus (for example, unfolding).

Optionally, the blanket extends laterally out of the ring through narrow channel 217. For example, as the thickened line 205 passes longitudinally through a channel in the guide (for example hollow 235 of the ring 213), a portion of the blanket extends longitudinally between the sides of a narrow passage 217.

FIG. 2C is a schematic diagram of an alternative guide 243 of a spreading apparatus for a fire resistant blanket in accordance with an embodiment of the current invention. In some embodiments, the narrow passage 247 may include a low friction surface component 245. For example, a low friction surface component 245 may include a Teflon object. Teflon coating or other friction reducing object. For example, the guide 243 may include a ring and/or the narrow passage 247 may include a cap in the ring.

In some embodiments, the guide may include a tube and/or a channel and/or a hedge (for example a wall and/or a barrier) and/or the narrow passage may include a slit along the guide. Alternatively or additionally, the guide may include a track which attaches to extensions attached to an edge of the blanket (for example rings to slide along a pole and/or a carriage that moves along fire track (e.g. a roller and/or a slider etc.)).

### Transportation of the Fire Blanket

FIG. 3A is a perspective view of a system for deploying a fire suppression system in accordance with an embodiment of the current invention. In some embodiments the blanket based fire suppression apparatus 301 includes a deployment apparatus 304 and or a spreading apparatus 314 (depicted in FIGS. 3A and 3C), 114 (spreading apparatus depicted in FIG. 1). Optionally the deployment apparatus 301 is coupled to a transport apparatus. Optionally, one or more transport apparatuses transport part or all of the blanket based fire suppression apparatus 301 to a designated deployment area.

In some embodiments the transport apparatus transports part or all of the blanket based fire suppression apparatus 301 while it is located inside the transport apparatus. Additionally, or alternatively, the transport apparatus transports part or all of the blanket based fire suppression apparatus 301 while it is located outside the transport apparatus. For example, the blanket based fire suppression apparatus 301 may be outside of but coupled to the transport apparatus.

In some embodiments part or all of the blanket based fire suppression apparatus 301 is first coupled to the transport apparatus while it is stationary. Additionally, or alternatively, pail or all of the blanket based fire suppression apparatus 301 is first coupled to the transport apparatus while it is in motion.

In some embodiments the transport apparatus is manned. Additionally, or alternatively, the transport apparatus is unmanned. Optionally, the transport apparatus is controlled remotely and/or automatically. In some embodiments the transport apparatus is motorized. Additionally, or alternatively, the transport apparatus is not motorized.

In some embodiments the transport apparatus is an aircraft. Optionally, the aircraft is a rotating wing aircraft. For example, the transport apparatus may be a helicopter 308, drone or other rotating wing aircraft. Additionally, or alternatively, the transport apparatus is a fixed wing aircraft. For example, the transport apparatus may be a propeller-powered plane, jet plane, glider and/or other type of fixed wing aircraft. Additionally, or alternatively, the transport apparatus is a water vessel. For example, the transport apparatus may be a boat, ship, barge, or other water vessel. Additionally, or alternatively, the transport apparatus is a land vehicle. For example, the transport apparatus may be a car, truck, fire truck, crane, tractor, military vehicle or other type of land vehicle. Additionally, or alternatively, the deployment apparatus is a stationary deployment apparatus 412 (depicted in FIG. 4). Optionally the stationary deployment apparatus 412 includes moving parts (e.g., as depicted in FIG. 4).

In some embodiments the blanket based fire suppression apparatus 301 comprises a lifting component 320. Optionally, the lifting component 320 changes the distance from the whole or from a part of the blanket based fire suppression apparatus 301 to the ground and/or to the transport apparatus to which the blanket based fire suppression apparatus 301 is coupled. For example, the lifting component 320 may raise or lower the blanket based fire suppression apparatus 301.

In some embodiments the raising or lowering of the blanket basal fire suppression apparatus 301 allows the blanket based fire suppression apparatus 301 to bypass obstacles, release tension in the system so that the deployed blanket may wrap around the contours of a building more tightly and/or maintain its distance to the ground while the transport apparatus to which the blanket based fire suppression apparatus 301 is coupled changes altitude.

In some embodiments the lifting component 320 comprises at least one of a winch, a hydraulic lifting mechanism, a screw based lifting mechanism, a pulley system, a moving arm, a telescopic arm, and/or a pivot based lifting device to raise and/or lower the blanket based fire suppression apparatus 301.

In some embodiments the blanket based fire suppression apparatus 301 comprises a safety disconnecting device 322. Optionally, the safety disconnecting device 322 disconnects all or pan of the blanket based fire suppression apparatus 301 from the transport apparatus.

In some embodiments at least one airflow manipulation device 318 is coupled to and/or incorporated into a spreading apparatus 314. Optionally, the airflow manipulation device 318 manipulates the position of guides 313 in relation to one another. For example, the airflow manipulation device 318 may exert pressure on two guides 313, each located at the end of a cable 307, to distance themselves from one another.

In some embodiments the blanket based fire suppression apparatus 301 comprises a steering device for suspended systems 329. Optionally, the steering device for suspended systems 329 stabilizes and/or changes the direction of the deployment path of the blanket based fire suppression apparatus 301 as it moves through the air during the deployment process.

In some embodiments the steering device for suspended systems 329 facilitates a deployment in which the deployment path of the blanket based fire suppression apparatus 301 is not a straight line. Optionally, the steering device for suspended systems 329 facilitates a deployment in which the deployment path of the blanket based fire suppression apparatus 301 is intended to align with the deployment path of an aircraft carrying the blanket based fire suppression apparatus 101, notwithstanding external factors. For example, the steering device for suspended systems 329 may align the deployment path of the blanket based fire suppression apparatus 301 with the deployment path of an aircraft carrying the blanket based fin: suppression apparatus 101, in spite of the force of the wind applied to the blanket based fire suppression apparatus 101.

In some embodiments the steering device for suspended systems 329 is an active steering device. For example, the steering device for suspended systems 329 may operate in a way that is similar to the operation of motorized rotating propellers. Additionally, or alternatively, the steering device for suspended systems 329 is a steering stabilizing device. For example, the steering device for suspended systems 329 may operate in a way that is similar to the operation of flaps and/or tail wings in aircrafts and/or other stabilizing devices.

In some embodiments the blanket based fire suppression apparatus 301 comprises at least one sensor 330. Optionally, the sensor 330 is a temperature sensor, distance measuring device, obstacle detection sensor, camera, pitch sensor, wind sensor, tension sensor and/or other sensor.

In some embodiments the blanket based fire suppression apparatus 301 comprises an applicator 331. Optionally, the applicator 331 deploys at least one fire suppressing material. Optionally, the applicator 331 deploys fire suppressing material onto the target and/or onto the fire blanket 102. For example, the applicator 331 may spray fire suppressing material in addition to deploying the fire blanket 102.

In some embodiments the applicator 331 deploys Fire suppressing material to a designated deployment area. For example, the applicator 331 may deploy water, fire retardants, a fire suppressing gas and/or another fire suppression material. Optionally, the applicator 331 deploys fire suppression material before, the fire blanket 102 (depicted in FIG. 1) is deployed, while the fire blanket 102 is being deployed, after the fire blanket 102 is deployed, below the fire blanket 102, above the fire blanket 102, on the bottom of the fire blanket 102 and/or on the top of the fire blanket 102.

In some embodiments at least one airflow manipulation device 318 is coupled to the fire blanket 102 (depicted in FIG. 1). Optionally, the airflow manipulation device 318 influences the flow of air around it. Optionally, the airflow manipulation device 318 comprises an aircraft steering device, an aircraft stabilizing device, a parachute, a wind sleeve, an air flow condenser and/or another device that manipulates airflow.

FIG. 3B is a perspective view of a system for deploying a fire suppression system hanging from a transport vehicle 358. In some embodiments, a blanket 351 is gathered in a hanging column shape (as illustrated in FIG. 3B), for example, for transport. Optionally, when the blanket is deployed it spreads out laterally from the center. For example, a pushing apparatus 352 may push the blanket extremities 353 outward from the blanket's center 354. For example, the blanket 351 may open like a parachute and/or an umbrella as it falls, before it falls and/or when it reaches a fire.

FIG. 3C is a perspective view of a system for deploying a fire suppression system. A deployment apparatus 394 (for example, an apparatus similar to apparatus 104 (depicted in FIG. 1)) optionally spreads a long blanket 392 to suppress, block and/or prevent a fire. For example, the long blanket 392 may cover a burning front of a fire to suppress the fire and/or may be laid down in front of an advancing fire to block the spread of the fire. For example, a transport component 398 (for example, an aircraft dragging the fire suppression system) may bring the fire suppression system to a deployment location and/or pass over the deployment location as the blanket 392 is deployed. For example, an extender, optionally including an anchor 391 (for example, a weight) may be dropped at the beginning a deployment zone. The anchor 391 optionally holds a trailing edge of the blanket 392 at the beginning of the deployment zone while the rest of the blanket is extended longitudinally along the deployment zone. A spreading apparatus 314 optionally spreads the blanket 392 laterally into a spread configuration 393 as it is deployed. Optionally, the spreading apparatus may include guides that spread the blanket 392. For example, as illustrated in FIG. 1. the guide may include a ring with a narrow passage through which passes a thickened line on a longitudinal edge of the blanket 392. In some embodiments, a wetting system 395 wets the blanket 392 as it is deployed.

In some embodiments an anchor 391 includes a cushioning layer. For example, a cushioning layer may be wrapped around an anchor to reduce the danger of causing damage on impact with an object and/or with people on the ground.

In some embodiments an anchor includes an alert and/or alarm component. For example, the alarm may alert ground staff of the approaching heavy anchors. Alternatively or additionally, the alarm may alert a flight crew and/or a deployment apparatus when the anchor makes contact (e.g., with the ground). Alternatively or additionally, the anchor may include a beacon to facilitate the location of the anchor.

In some embodiments an anchor includes a release mechanism. For example, a release mechanism may release the anchor at the desired location to begin the deployment process. For example, the release mechanism may disconnect the anchor from the blanket when retrieving the blanket and/or when the anchor is mispositioned.

### Stationary Deployment System

FIG. 4 is a perspective view of a stationary system for deploying a fire suppression system in accordance with an embodiment of the current invention. In some embodiments a blanket based fire suppression apparatus 412 is deployed around a building.

In some embodiments, the blanket based fire suppression apparatus (e.g., an apparatus similar to system 101 and 301) is coupled to a transport apparatus. Optionally, the transport apparatus is a stationary deployment apparatus 412. Optionally, the apparatus 412 includes moving parts. Optionally, the stationary deployment apparatus 412 transports the blanket based fire suppression apparatus to a designated deployment area and/or facilitates the deployment of the blanket based fire suppression apparatus above a designated area. For example, the stationary deployment apparatus 412 may deploy the fire blanket 102 (e.g., as depicted in FIG. 1) above and/or around a facility or house.

In some embodiments, the stationary deployment apparatus 412 comprises a stationary support. Optionally, the stationary deployment apparatus 412 comprises and/or is coupled to components that move in respect to the frame of the stationary support and/or to the stationary deployment apparatus. Optionally, the mobility of components of the stationary deployment apparatus 412 facilitates the deployment of the blanket based fire suppression apparatus. Optionally, the movement of components of the stationary deployment apparatus 412 and/or a spreading apparatus 414 spread out the fire blanket 102 (depicted in FIG. 1). For example, a deployment apparatus 404 (e.g., apparatus 104 depicted in FIG. 1) may move along and/or in relation to a stationary track (for example a guide wire 419).

In some embodiments the movement of the moving parts of the stationary deployment apparatus 412 is assisted by at least one pulley. For example, deployment apparatus 404 may be supported by a pulley wheel 481 traveling along a track. For example, deployment pulley wheel 481 may be pulled along a truck by a Fixed pulley and/or could include a motor that rotates a pulley wheel 481 to travel along the track.

In some embodiments the moving parts of the stationary deployment apparatus 412 are moved by the action of a motorized device and/or by the action of a manually controlled device. Optionally, the motorized device and/or the manual device are incorporated into and/or coupled to the stationary deployment apparatus 412,

In some embodiments the moving parts of the stationary deployment apparatus 412 are moved by the force of gravity.

In some embodiments the stationary deployment apparatus 412 comprises cables 419 that are configured to facilitate the movement of the blanket based fire suppression apparatus above a designated area. In some embodiments the cables 419 are incorporated into and/or coupled to the stationary deployment apparatus 412.

In some embodiments the cables 419 of the stationary deployment apparatus 412 facilitate the deployment of the fire blanket 102 (e.g. as depicted in FIG. 1). For example, as the blanket based fire suppression apparatus moves along on a pre-installed system of cables 419 of the stationary deployment apparatus 412, the fire blanket 102 spreads. Optionally, the fire blanket 102 spreads as it is deployed above a designated deployment area.

### Configuring and Positioning the Fire Blanket

In some embodiments the blanket based fire suppression apparatus comprises a lilting component 420 (for example including component 320 depicted in FIG. 3A). Optionally, the lifting component 420 changes the distance from the whole or from a part of the blanket based fire suppression apparatus to the ground and/or to the transport apparatus to which the blanket based fire suppression apparatus is coupled. For example, the lifting component 420 may raise or lower the blanket based fire suppression apparatus.

In some embodiments at least one airflow manipulation device 418 (for example similar to device 318 depicted in FIG. 3A) is coupled to and/or incorporated into a spreading apparatus 114 and/or the fire blanket 102 (e.g. as depicted in FIG. 1). Optionally, the airflow manipulation device 418 manipulates the position of guides 413 in relation to one another. For example, guides may include rings with narrow passages, for example, rings 213 and/or 243 as illustrated in FIGS. 2A-2C. For example, the airflow manipulation device 418 may exert pressure on guides 413, each located at the end of a cable, to distance themselves from one another.

In some embodiments the blanket based fire suppression apparatus (for example apparatus 412) includes a gravity assisted spreading apparatus. Optionally, the gravity assisted spreading apparatus utilizes the force of gravity to spread the fire blanket 102 (depicted in FIG. 1). Optionally, the gravity assisted spreading apparatus utilizes cables to unfold the fire blanket 102. Optionally, the cables utilized by the gravity assisted spreading apparatus are tilted at an angle to the ground. Optionally, the fire blanket 102 is released to slide down on the tilted cables utilized by the gravity assisted spreading apparatus. Optionally, the fire blanket 102 spreads out as if slides down on the tilted cables utilized by the gravity assisted spreading apparatus.

In some embodiments, a weight 506 is coupled to the blanket 502. For example, an elongated weight 506 may run along a longitudinal and/or a lateral edge of the blanket 502. Optionally, the weight 506 is incorporated into the structure of said blanket 502 in a way that during the deployment process, the force of gravity will influence the weight 506, in a way that causes the blanket 502 to spread. For example, the weight 506 may facilitate a vertical deployment of the blanket 502 around a vertical, or nearly vertical, object, for example, the walls of a building. For example, a thickened line 505 on one edge of the blanket may be thinner and/or lighter than a thickened line that includes the weight 506 on another edge. Optionally, the guides of the deployment apparatus 501 are configured to accommodate the thickened line.

Spreading the Fire Blanket with Weights

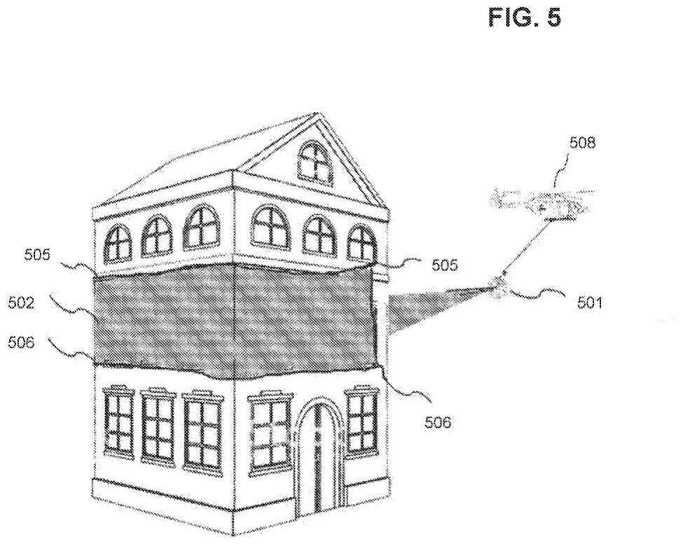

FIG. 5 is a perspective view of a system for deploying a fire suppression system to a building in accordance with an embodiment of the current invention. In some embodiments the fire blanket 502 comprises and/or is coupled to at least one weight 506. Optionally, one or more weights 506 exert a fora: on the fire blanket 502. Optionally, the weights 506 are incorporated into the fire blanket 502. Optionally, the weights 506 are coupled to parts of the fire blanket 502.

In some embodiments the coupling of the weights 506 to the fire blanket 502 increases the weight of the fire blanket 502 at the area where it is attached. Optionally, weights are coupled to the edges of the fire blanket 502. Optionally, the coupling of the weights 506 in the edges of the fire blanket 502 pushes the edges of the fire blanket 502 down. Optionally, the coupling of the weights 506 to the edges of the fire blanket 502 pushes the edges of the fire blanket 502 down alter deployment, reducing air flow beneath the fire blanket 502. Optionally, the reduced air flow beneath the fire blanket 502 reduces the strength of the fire.

In some embodiments the weights 506 are elongated weights. Optionally, the weights 506 comprise a series of separate weights. Optionally,

In some embodiments the force exerted on the fire blanket 502 by one or more weights 506 causes the fire blanket 502 to spread out. For example, one or more weights 506 may pull the fire blanket 502 downward through gravitational force. Optionally, as the fire blanket 502 is pulled downward, it unfolds.

In some embodiments one or more weights 506 is used in place of one or more thickened lines 505 in the spreading of the fire blanket 502. Optionally, one or more weights 506 replaces one or more thickened lines 505 in the composition of the fire suppression apparatus 501. Optionally, one or more weights 506 together with one or more thickened lines 505 spread the fire blanket 502 in a vertical or other type of deployment. For example, a fire blanket 502 may be unfolded by manipulating the upper side of the fire blanket 502 with a thickened line 505 while an elongated weight 506 manipulates the lower, opposite side of the fire blanket 502. For example, a fire blanket 502 may be spread and/or deployed around a building by manipulating the upper side of the fire blanket 502 with at least one thickened line 505 while at least one elongated weight 506 manipulates the lower, opposite side of the fire blanket 502. Optionally a longitudinal edge of the blanket may be suspended by line 505. For example, line 505 may be suspended, for example, by attachment to a wall of a building and/or by being lightly wrapped around a wall of a building. Optionally, an opposite longitudinal edge drapes downward under the force of weights 506. Alternatively or additionally, a blanket hangs longitudinally downward (e.g., rotated 90 degrees with respect to blanket 502).

In some embodiments the fire suppression apparatus 501 is transported to the deployment site by an aircraft For example, the fire suppression apparatus 501 may be transported to the deployment site by a helicopter 508.

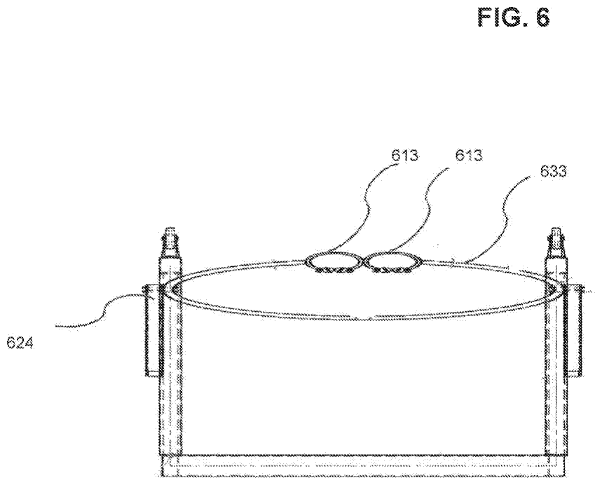

FIG. 6 is a schematic diagram of a refolding apparatus 624 for a fire resistant blanket in accordance with an embodiment of the current invention. In some embodiments, the refolding apparatus 624 causes thickened lines 105 (e.g., as depicted in FIG. 1) to move a fire blanket 102 (e.g., as depicted in FIG. 1) to pass through narrow guides 613. The refolding apparatus 624 is optionally capable of receiving a fire blanket 102 in its spread configuration and folding it back to its folded configuration for reuse. Optionally, guides 613 (for example rings 213 and/or 243 as illustrated in FIGS. 2A-2C) draw the edges of the blanket back together to a gathered configuration. In some embodiments the refolding apparatus 624 includes a Tunneling device 633 to allow a more efficient refolding.

### Post Deployment Procedure

In some embodiments the blanket based fire suppression apparatus 101 (depicted in FIG. 1) comprises a refolding apparatus 624. Optionally, the refolding apparatus 624 receives the fire blanket 102 (depicted in FIG. 1) in a spread configuration and folds it back to its folded configuration. Optionally, the refolding apparatus 624 is employed after a deployment of the fire blanket 102 (depicted in FIG. 1). Optionally, the refolding apparatus 624 is employed in order to prepare the tire blanket 102 for redeployment in the same fire suppression operation or for use in a different fire suppression operation. Optionally, the refolding apparatus 624 comprises or is coupled to at least one narrow passage. Optionally, the refolding apparatus 624 causes the thinner material of the fire blanket 102 to run through at least one narrow passage. Optionally, the movement of at least part of the fire blanket 102 through at least one narrow passage folds the fire blanket 102. Optionally, the refolding eases the transportation of the fire blanket 102 and/or allows for its reuse.

In some embodiments the refolding apparatus 624 is a standalone apparatus. Additionally, or alternatively, the refolding apparatus 624 is coupled to a deployment apparatus 104 (depicted in FIG. 1).

In some embodiments the refolding apparatus 624 comprises a funneling device 633. Optionally, the Tunneling device 633 is configured to increase the efficiency of the refolding of the fire blanket 102 (depicted in FIG. 1).

In some embodiments the blanket based fire suppression apparatus 101 (depicted in FIG. 1) comprises at least one post deployment locator 123 (depicted in FIG. 1). Optionally, the post deployment locators 123 are coupled to the fire blanket 102 (depicted in FIG. 1). Optionally, the post deployment locators 123 indicate the location of the fire blanket 102 as a whole and/or a specific part of the fire blanket 102. For example, the post deployment locators 123 may indicate the location of one or more comers of the fire blanket 102.

In some embodiments the post deployment locators 123 (depicted in FIG. 1) emit a signal. Optionally, the post deployment locators 123 emit a signal after the fire blanket 102 has been deployed. For example, the post deployment locators 123 may emit light, sound, an electronic signal or other wireless communication and/m another type of signal. Optionally, the signal emitted by the post deployment locators 123 facilitates the location and/or recovery of the fire blanket 102 (depicted in FIG. 1). Optionally, the fire blanket 102 is reused following its location and/or recovery. Optionally, the fire blanket 102 is tested, repaired and/or maintained following its use and/or on a regular basis. Additionally, or alternatively, the fire blanket 102 is reused immediately following its use. For example, the fire blanket 102 may be deployed to a designated area affected and/or threatened by an active fire and when it is needed in another area affected by the same fire and/or a different fire, it may be located, recovered and redeployed without undergoing testing, repair and/or maintenance. Optionally, the fire blanket 102 may be redeployed following its use after being tested in the field, without undergoing repair or maintenance.

In some embodiments the post deployment locators 123 (depicted in FIG. 1) are inflatable. Optionally, the post deployment locators 123 are inflated before, during and/or after deployment of the fire blanket 102 (depicted in FIG. 1).

In some embodiments the blanket based fire suppression apparatus 101 (depicted in FIG. 1) comprises a post deployment flattening apparatus 128 (depicted in FIG. 1). Optionally, the post deployment flattening apparatus 128 applies pressure to the surface of the fire blanket 102 (e.g. as depicted in FIG. 1) after it has been unfolded and/or deployed. Optionally, the pressure applied to the surface of the fire blanket 102 by the flattening apparatus 128 reduces the amount of air trapped under the fire blanket 102. Optionally, the reduction of the amount of air trapped under the fire blanket 102 increases the efficiency of the fire blanket 102 in suppressing a fire. Optionally, the post deployment flattening apparatus 128 comprises heavy cables, chains or other items that may be positioned to apply pressure to the surface of the fire blanket 102.

### Components of Fire Suppression System

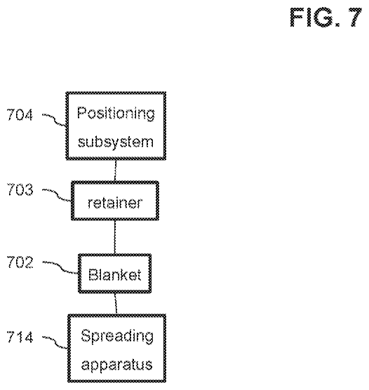

FIG. 7 is an exemplary block diagram illustrating the relationship between the components of a fire suppression system in accordance with an embodiment of the current invention. In some embodiments, the system may include a fire resistant and/or fire retardant blanket 702. In some embodiments, the system may include a retainer 703 for storing and/or transporting a fire resistant blanket 702. For example, the blanket 702 may be stored and/or transported inside the retainer 703 and/or wrapped around the retainer 703 and/or the retainer 703 may include a folding frame for holding, folding and/or unfolding the blanket 702. In some embodiments, the system may include a positioning subsystem 704. For example, the positioning subsystem 704 may include a transport vehicle and/or a stationary structure to position the blanket over a deployment location and/or drop the blanket onto the deployment location. Optionally, the blanket 702 is stored and/or transported in a reduced surface area state (for example folded and/or rolled up). Optionally, the fire suppression system may include a spreading apparatus 714 to spread out the blanket at a deployment location.

### Fire Suppression Methods

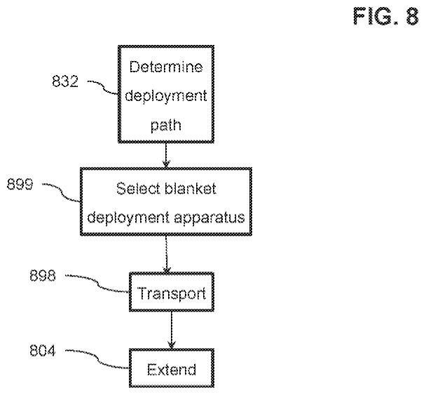

FIG. 8 is a flow chart illustration of a method of suppressing fire in accordance with an embodiment of the current invention. In some embodiments, a plan of deployment will be determined 832. For example, a computer system may be used to track the locations of fire, fuel, likely wind conditions, etc. The computer may gather data from reports of fire fighters in the field, observation devices (e.g., aircraft, satellites), automated sensors in the field, weather reports, city plans, forest maps, etc.

In some embodiments, a fire suppression blanket will be transported 898 to a deployment location. For example, the blanket may be gathered and/or fixed to a storage retainer and/or the retainer and blanket may be transported 898 by land, air and/or sea lo a deployment location. Optionally, at the deployment location, the blanket is deployed 804. For example, deployment 804 may include unfolding the blanket above the deployment location (e.g., while being transported by a moving aircraft and/or suspended from an aerial platform and/or a stationary platform). Optionally the blanket is then dropped and/or spread onto a deployment location in the path of a fire and/or to protect an escape route from the fire and/or to directly suppress the fire (for example, depriving it of air) and/or to protect an object (i.e., covering a building to prevent it from being ignited).

For example, a blanket may be deployed 804 in the path of an advancing fire. For example, a deployment path on the ground may be determined 832. Optionally, a suitable geometry of the blanket and/or a suitable deployment system may be selected 899. For example, selection 899 may include knowledge about the size and/or geometry of the deployment zone, the availability of manpower and/or equipment, the accessibility of the deployment zone, how much time is available to deploy the blanket (e.g., until the fire reaches the deployment location). In some embodiments, the blanket may be transported 898 to the designated deployment area. For example, transport may be achieved using a transport apparatus.

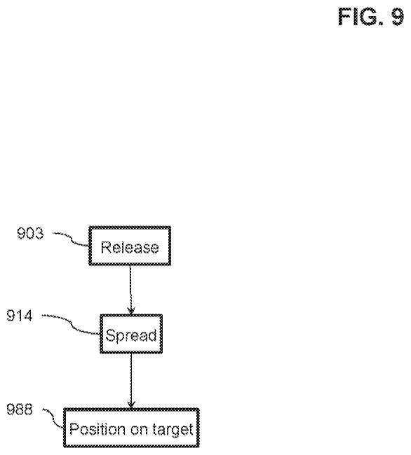

FIG. 9 is a flow chart illustration of a method of deploying a blanket in accordance with an embodiment of the current invention. In some embodiments, after a blanket has reached a deployment area it is deployed. For example, the blanket may be released 903 from an aircraft. Releasing 903 may include, for example, opening a storage retainer (for example, a cargo area of the aircraft and/or a storage retainer suspended from the aircraft) and/or unrolling the blanket from a roller. Optionally, the blanket will be spread 914 before reaching the target zone. For example, a spreading apparatus may spread (for example, unfold) the blanket as it is released from an aircraft (for example as illustrated in FIGS. 1 and/or 3A and/or 3B). Alternatively or additionally, a blanket may be spread 914 by a ground crew after it reaches the deployment location.

In some embodiments a blanket is positioned on a deployment zone. For example, a blanket may be dropped from an aircraft. Alternatively or additionally, an anchor and/or a weight may be used to position 988 a portion of the blanket. For example, a trailing portion of the blanket may be anchored to a starting location as the rest of the blanket is spread 914 over a deployment location (for example as illustrated in FIG. 3C). Alternatively or additionally, a weight may be used to spread 914 a bottom portion of a blanket away from a top portion (for example as illustrated in FIG. 5).

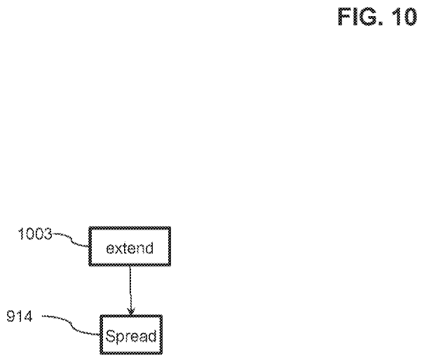

FIG. 10 is a flow chart illustration of deploying a blanket an accordance with an embodiment of the current invention. For example, a blanket may be deployed by extending 1003 it longitudinally along and/or a across a target zone. As the blanket is extended 1003, it may optionally be spread 914 laterally.

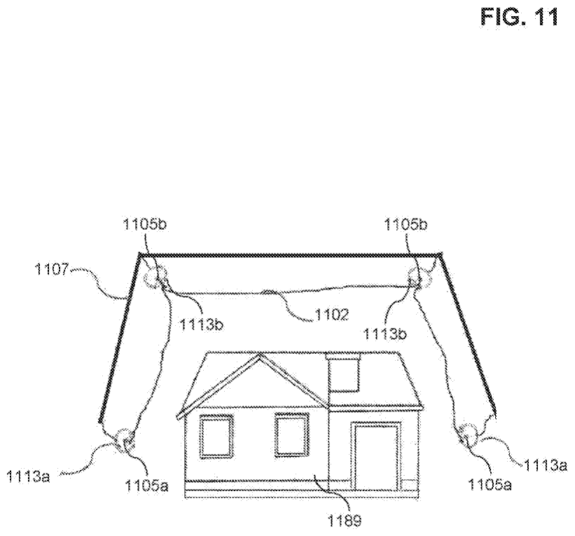

FIG. 11 is a schematic illustration of a fire suppression system in accordance with an embodiment of the current invention. For example, a spreading apparatus may include guides on a frame 1107. The frame 1107 may be positioned over a target (for example a building 1189). Optionally a Fire resistant blanket 1102 is extended along guides 1113a, 1113b on the frame 1107 to cover the target. For example, guides 1113a and/or 1113b may include a channel through which passes a thickened portion 1105a, 1105b of the blanket. For example, a thickened portion 1105a may be on an edge of the blanket and/or one layer of the thin portion of the blanket may pass through a narrow passage in out of the guide 1113a. For example, a thickened portion 1105b may be on an interior of the blanket and/or the blanket may be folded over inside the channel such that two layers of the thin portion of the blanket may pass through a narrow passage in out of the guide 1113b.

In some embodiments, the frame 1107 may be mobile and/or a trailing portion of the blanket 1102 may be held stationary as the frame 1107 and/or a leading portion of the blanket 1102 are pulled longitudinally across the target extending the blanket 1102 over the target. Alternatively or additionally, the frame 1107 may be stationary and/or a trailing portion of the blanket 1102 may be held stationary to the frame 1107 as a leading portion of the blanket 1102 is pulled longitudinally along the frame across the target extending the blanket 1102 over the target. Optionally, as the blanket 1102 is extended, the guides 1113a, 1113b and/or the frame 1107 spread the blanket 1102 laterally over the target.

In some embodiments, extending may include starting the deployment process at a designated starting point. For example, an anchor may be placed at the beginning of the deployment path. In some embodiments, as the blanket is deployed, its configuration may be changed from a reduced surface area configuration to a fully spread configuration. Optionally, the cross section shape may be configured to the desired cross section to facilitate deploying the blanket onto the deployment area.

In some embodiments, deploying a fire resistant blanket may include further optional steps. For example, a fire suppressing material may be applied to the blanket as it is extended. For example, a fire suppressing material may be applied to the blanket before and/or after the blanket is placed on a target location. Alternatively or additionally, the fire suppressant may be applied to the target location before deploying the blanket.

In some embodiments, the blanket may be retrieved from a deployment location. For example, the blanket may be retrieved for proper disposal and/or to lie recycled for reuse. Optionally the blanket may be refolded. For example, a refolding apparatus may be used to refold the blanket (e.g., as illustrated in FIG. 6).

In some embodiments, a fire suppressing blanket may be deployed directly onto a fire. For example, the steps may be the same as when deploying in the path of a fire, hut the deployment path is directly on the fire.

In some embodiments, a fire suppressing blanket may be deployed to create an escape route from a fire danger zone. For example, the method may be similar to the steps deploying a blanket in the path of a fire, but the selected geometry of the blanket and/or the deployment location may be chosen to protect and/or create an escape route from the fire.

In some embodiments, a fire suppressing blanket may be deployed to create and/or delimit an area that will be burned deliberately. Optionally, the method is similar to positioning a blanket in the path of a fire, but the deployment path and the selected embodiment of the blanket are adapted to controlling and/or delimiting a fire that is deliberately set at the edge of an area designated to be deliberately burned. For example, an area in the path of an uncontrolled fire may be selected (for example, to deprive it of fuel and/or to prevent it from spreading to a sensitive (e.g., populated) area.

In some embodiments, a fire suppressing blanket may be deployed to cover a building or an object. Optionally, the steps are similar to those of deploying a blanket in the path of a fire, but the deployment path and the selected embodiment of the blanket are adapted to being deployed over a specific object (for example, as illustrated in FIG. 5).

In some embodiments, a fire suppression blanket is deployed by a stationary deployment apparatus. Optionally, the stationery deployment apparatus includes moving parts. For example, the apparatus may be configured and/or used to cover a building and/or an object with a fire suppressing blanket.

In some embodiments, an object vulnerable to fire and/or particularly important to protect may be identified. For example, the object may be in the path of an existing fire and/or the object may be identified before a fire has occurred.

In some embodiments, preparation may be made prior to deployment of the blanket. For example, non-limiting examples include erecting at least one pole and/or deploying at least one cable for the deployment of a blanket.

At a time of danger and/or when a fire is threatening an object, a blanket is optionally deployed. For example, deployment may include changing a configuration of the blanket. For example, the blanket may be unfolded to its spread configuration and/or deployed above a deployment area. Optionally a fire suppression material may be applied with the blanket. Optionally the deployed blanket may be retrieving after use. For example, the blanket may be disposed of and/or reused (for example refolded and/or repositioned).

In some embodiments, a fire blanket and/or blanket based fire suppression system may be wrapped around a section of a multi story building, (e.g. as illustrated in FIG. 5). For example, a deployment path may be determined 832 and/or equipment may be selected 899 and/or the system may be transported 898 to the building

In some embodiments, deploying 804 the blanket may include anchoring a tip of the fire blanket to an object and/or a device on the building. For example, the blanket may be anchored to the structure of the building.

In some embodiments, the blanket may be spread over and/or wrapped around the building. For example, by surrounding one or more sides of the building while deploying the blanket. Optionally a fire suppressing material may be applied and/or the blanket may be retrieved after use.

In some embodiments the blanket based fire suppression apparatus 101 (depicted in FIG. 1) blocks the path of an advancing fire by: identifying an active fire; determining a deployment path on the ground with or without the assistance of the firefighting computerized decision assisting system; selecting the most suitable of the available configurations of the blanket based fire suppression apparatus 101 for suppressing and/or blocking the (ire; transporting the blanket based fire suppression apparatus 101 to the designated deployment area with the assistance of the transport apparatus most suitable for transport to that area; starting the deployment process in the designated starting point of the deployment path. Optionally, the blanket 102 is transported along with and extender, for example anchors 126. For example, the blanket may deployed (e.g. extended) with or without dropping the anchor 126; running the fire blanket 102 through the deployment apparatus 104 in a way that forces it to change its configuration from its folded configuration to its spread out configuration and/or to change its cross section shape to the desired cross section and/or allowing the fire blanket 102 to be deployed above the designated deployment area; spraying or otherwise deploying a fire suppressing material with the assistance of the applicator 331: retrieving the deployed fire blanket 102 to be discarded or to be recycled for reuse; and/or refolding the fire blanket 102 for reuse with or without the assistance of the refolding apparatus 624 (depicted in FIG. 6).

In some embodiments the above method of utilizing the blanket based fire suppression apparatus 101 (depicted in FIG. 1) is adapted to suppress an active fire by deploying the fire blanket 102 directly on the fire or on an object on fire.

In some embodiments the above method of utilizing the blanket based fire suppression apparatus 101 (depicted in FIG. 1) is adapted to create an escape route from a fire danger zone by configuring the deployment to facilitate the suppression of fire at the edge of a forest.

In some embodiments the above method of utilizing the blanket based fire suppression apparatus 101 (depicted in FIG. 1) is adapted to bum an area as a preventative step by configuring the deployment path, deployment and blanket based fire suppression apparatus 101 to facilitate deployment at the edge of an area designated to be deliberately burned.

In some embodiments the blanket based fire suppression apparatus 101 (depicted in FIG. 1) suppresses an active fire in a building or other object with the assistance of a stationary deployment apparatus 412 (depicted in FIG. 4) by: identifying a fire in or near a building or on another object; selecting the most suitable of the available configurations of the blanket based fire suppression apparatus 101 for suppressing and/or blocking the fire; optionally preparing for the deployment, for example, by erecting at least one pole and/or deploying at least one cable needed for the deployment; beginning the deployment process; running the fire blanket 102 (depicted in FIG. 1) through the deployment apparatus 104 (depicted in FIG. 1) in a way that forces it to change configuration from its folded configuration to its spread configuration and to change its cross section shape to the desired cross section and facilitating the deployment of the fire blanket 102 above the designated deployment area; optionally spraying or otherwise deploying a fire suppressing material with the assistance of the applicator 331; retrieving the deployed fire blanket 102 to be discarded or to be recycled for reuse: and optionally refolding the fire blanket 102 for reuse with or without the assistance of the refolding apparatus 624 (depicted in FIG. 6).

In some embodiments the blanket based fire suppression apparatus 101 (depicted in FIG. 1) wraps the fire blanket 102 around a multi story or other building on fire by: identifying an active fire in or near a building; selecting the most suitable of the available configurations of the blanket based fire suppression apparatus 101 for suppressing and/or blocking the fire; transporting the blanket based fire suppression apparatus 101 to the designated deployment area with the assistance of the transport apparatus most suitable for transport to that area; anchoring a tip of the fire blanket 102 to an object and/or device in the structure of the burning or threatened building; beginning the deployment process; running fire blanket 102 through the deployment apparatus 104 in a way that forces it to change configuration from its folded configuration to its fully spread configuration and to change its cross section shape to the desired cross section and allowing the fire blanket 102 to be deployed around the burning or threatened building; continuing the deployment by surrounding at least one side of the burning or threatened building while deploying the fire blanket 102, continuing the deployment until the designated wrapping pattern is achieved, such as wrapping all four sides of a building; optionally spraying or otherwise deploying a fire suppressing material with the assistance of the applicator 331; retrieving the deployed fire blanket 102 to be discarded or to be recycled for reuse; optionally refolding the deployed fire blanket 102 for reuse with or without the assistance of the refolding, apparatus 624 (depicted in FIG. 6).

### Fire Suppression Examples

In some embodiments the blanket based fire suppression apparatus 101 (depicted in FIG. 3) deploys the fire blanket 102 (depicted in FIG. 1) directly on a fire and/or an object (such as a building, boat, aircraft and/or other object) or area affected by a fire.

In some embodiments the blanket based fire suppression apparatus 101 (depicted in FIG. 1) deploys the fire blanket 102 on an object or area potentially in the path of a fire.

In some embodiments the blanket based fire suppression apparatus 101 (depicted in FIG. 1) deploys the fire blanket 102 to create an escape route from a fire. Optionally, the fire blanket 102 is deployed in a configuration adapted to create an escape route at the edge and/or the middle of a forest.

In some embodiments the blanket based fire suppression apparatus 101 (depicted in FIG. 1) deploys the fire blanket 102 to cover a structure on the ground from the air by using an aircraft as a transport apparatus.

In some embodiments the blanket based fire suppression apparatus 101 (depicted in FIG. 1) deploys the fire blanket 102 to cover a structure on the ground from the ground by using an on-land motorized vehicle.

In some embodiments the blanket based fire suppression apparatus 101 (depicted in FIG. 1) deploys the fire blanket 102 to cover a structure on the ground from the ground by using the stationary deployment apparatus 412.

In some embodiments the blanket based fire suppression apparatus 101 (depicted in FIG. 11 deploys the fire blanket 102 around part or all of a building. For example, a helicopter 508 may be used to deploy the fire blanket 102 around a section of a multi-story building.

In some embodiments the blanket based fire suppression apparatus 101 (depicted in FIG. 11 deploys the fire blanket 102 above a fire and/or in the path of fire and/or above a structure, and, in addition, the applicator 331 spray s a fire suppressing material on the deployment area and/or under and/or above the fire blanket 102.

In some embodiments the blanket based fire suppression apparatus 101 (depicted in FIG. 1) deploys the fire blanket 102 around a designated area as a preventative measure. For example, the blanket based fire suppression apparatus 101 may deploy the fire blanket 102 around an area that is threatened by an active and/or potential fire. Optionally, the blanket based fire suppression apparatus 101 deploys the file blanket 102 around a threatened area after a fire is intentionally set in the threatened area. Optionally, the blanket based fire suppression apparatus 101 deploys the fire blanket 102 on at least one side of a threatened area. For example, the blanket based fire suppression apparatus 101 deploys the fire blanket 102 on the side of a threatened area toward which the wind is blowing.

In some embodiments the firefighting computerized decision assisting system is used to collect data and prepare for potential future fires, in areas at high risk for fire, by determining, before a fire starts in a particular area, the preferred deployment route of the fire blanket 102 in the case that a fire starts in that area.

It is expected that during the life of a patent maturing from this application many relevant technologies will be developed and the scope of the terms used herein is intended to include all such new technologies a priori.

As used herein the term “about” refers to ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially after the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range formal. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc. as well as individual numbers within that range, for example. 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A fire suppressing system including:
a fire resistant blanket, in a reduced surface area configuration, thickened portions said blanket;
an extender configured to extend the blanket over a target zone;
a guide configured to spread said blanket laterally as it is extended; said guide including a narrow passage through which passes a thin portion of the blanket while said thickened portion is retained on one side of the narrow passage.

2. The system of claim 1, wherein said extender is configured to extend the blanket longitudinally or over the target zone.

3. The system of claim 1, wherein said thickened portions are integrated into the blanket.

4. The system of claim 1, wherein said thickened portions include a thickened longitudinal line.

5. The system of claim 1, further comprising:
a wind sheltering component configured to reduce an impact of wind on the blanket during deployment thereof.

6. The system of claim 1, further comprising:
a lifting component configured to change a distance of a part of the system to a ground without changing a distance of a transport to which the system is coupled to the ground.

7. The system of claim 1, further comprising:
a lifting component configured to change a distance of a part of the system to a transport apparatus to which the system is coupled.

8. The system of claim 2, further comprising:
a safety disconnecting device configured to disconnect at least one member selected from the set consisting of said extender, said guide and said blanket from a transport apparatus that is transporting the system.

9. The system of claim 1, further comprising:
an applicator configured for applying a fire suppressing material.

10. The system of claim 1, further comprising:
a retainer configured for holding said blanket in said reduced surface area configuration.

11. The system of claim 1, wherein said retainer is configured to hold said blanket above a deployment zone and release said blanket from said reduced surface area configuration.

12. The system of claim 1, where said extender includes at least one member of the set consisting of an anchor, a weight, an attachment mechanism, a pulley, a drive wheel and an airflow manipulation device.

13. The system of claim 1, further comprising a transport apparatus configured for transporting said, blanket in said reduced surface area configuration over a target.

14. The system of claim 13, wherein said transport apparatus is further configured for transporting said extender.

15. The system of claim 14, wherein said transport apparatus is further configured to release said extender over a target region.

16. The system of claim 1, wherein said extender includes at least one member of the set consisting of an anchor, a weight, an attachment mechanism, and an airflow manipulation device.

17. The system of claim 1, further comprising a stationary deployment apparatus configured for suspending a portion of said blanket in said reduced surface configuration over a target while the blanket is extended.

18. The system of claim 13, wherein said transport apparatus includes at least one member of the set consisting of a fixed wing aircraft, a rotating wing aircraft, a ground vehicle and a water vehicle.

19. The system of claim 1, wherein said guide includes an airflow manipulation device configured to control a position of said blanket as it is deployed.

20. The system of claim 1, wherein said system includes an airflow manipulation device configured to control a position of said blanket as it is deployed.

21. The system of claim 1, wherein said guide includes a ring and wherein said narrow passage includes a gap in said ring.

22. The system of claim 1, wherein said thickened portion includes at least one line running along an edge of said blanket.

23. The system of claim 1, wherein said narrow passage includes a friction reducing mechanism.

24. The system of claim 23, wherein said friction reducing mechanism includes a rolling element.

25. The system of claim 1, further including a flattening apparatus.

26. The system of claim 1, further including a refolding apparatus.

27. The system of claim 1, further including a location indicator attached to said blanket.

28. The system of claim 1, wherein said retainer includes a roller configured to roll up or unroll said blanket.

29. The system of claim 1, further comprising a deployment speed configured to limit a rate of extending of said blanket.

30. A method of fire suppression comprising:
transporting a fire resistant blanket in a reduced surface area configuration to a target,
suspending said blanket over the target;
spreading the blanket laterally [symbol] during said suspending.

31. The method of claim 30 further comprising
extending the blanket longitudinally during said spreading.

32. The method of claim 30, further comprising unfolding said blanket during said spreading.

33. The method of claim 30, further comprising:
anchoring a trailing portion of the blanket onto a starting position and
extending the blanket from the trailing portion over the target.

34. The method of claim 30, further comprising anchoring a top portion of the blanket onto a starting position and spreading the blanket downward from the top portion over the target.

35. The method of claim 30, further comprising:
selecting a burning location as said target.

36. The method of claim 30, further comprising:
selecting a location in a path of a fire as said target.

37. The method of claim 30, further comprising:
selecting a location protecting an escape route from said fire as said target.

38. The method of claim 30, further comprising:
applying a fire suppressing chemical to at least one of said target or said blanket.

39. The method of claim 30, wherein said suspending and said spreading are from a flying aircraft.

40. The method of claim 31, wherein said extending includes attaching a top portion of said blanket to a building and draping a lower portion of said blanket over a wall of the building.

41. The method of claim 30, wherein said spreading includes passing an edge of said blanket along a guide.

42. The method of claim 40, wherein said spreading includes at least one of weighing down a lower portion of said blanket or spreading the blanket due to airflow resistance.

43. The method of claim 30, further comprising:
wrapping said blanket around a building.

44 The method of claim 30, further comprising:
retrieving said blanket after said spreading.

45. The method of claim 44, further comprising:
refolding said blanket.
